(19) United States
(12) Patent Application Publication
(10) Pub. No.: US 2003/0129975 A1
(43) Pub. Date: Jul. 10, 2003

(54) Method of performing communication function with hot key in mobile communication terminals

(75) Inventor: Ji-Saob Sim, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/339,154

(22) Filed: Jan. 9, 2003

(30) Foreign Application Priority Data
Jan. 10, 2002 (KR) P2002-1468

(51) Int. Cl. H04M 3/42; H04M 3/00; H04Q 7/20

(52) U.S. Cl. 455/418; 455/414; 455/466

(57) ABSTRACT

The invention relates to a method of performing various communication functions with hot keys in a mobile communication terminal. Hot keys are allocated to the various communication functions to set the communication functions as hot key functions. When number keys are inputted, various communication modes are set according to user selection and corresponding communications are performed in respect to destinations stored in address numbers identical with inputted numbers so as to promote the convenience of a user.

### PRIORITY

This application claims priority to an application entitled “METHOD OF PERFORMING COMMUNICATION FUNCTION WITH HOT KEY IN MOBILE COMMUNICATION TERMINALS” filed in the Korean Intellectual Property Office on Jan. 10, 2002 and assigned Serial No. 2002-1468, the contents of which are incorporated herein by reference.

### BACKGROUND OF THE INVENTION

1. Field of the Invention

The present invention relates to a mobile communication terminal, and more particularly, to a method of performing various communication functions with hot keys in mobile communication terminals.

2. Description of the Related Art

Hot keys are used to simply invoke frequently used specific functions by inputting specific keys without user operations requiring multiple steps such as menu selections required for performing the specific functions. Hereinafter those functions each invoked by the hot keys will be referred to as “hot key functions.” Mobile communication terminals define a plurality of number keys or function keys as hot keys for the convenience of the user. For example, the number key ‘#’ being defined as a vibration mode conversion key. Generally in execution, a number of functions allocated to the hot keys, i.e. hot key functions, are defined according to key input methods of users.

Operations related to communication functions of mobile communication terminals are also performed through hot keys. As a representative example thereof, in an audio communication function, number keys are used as hot keys to perform dialing for audio conversation. In the application, the communication function is a function relating to a communication service carried out with another mobile communication terminal, and includes an audio conversation function, a short message service function, an Internet communication function, a radio data transmission/receiving function, and the like.

The dialing function using the number keys as the hot keys is performed according to the following sequence: a user inputs specific number keys corresponding to a specific address in an address book storing a specific telephone number to which the user wants to call. If the user inputs a number key corresponding to the last number of the specific address, when the last number key is pressed for a predetermined time or longer, the mobile communication dials the specific telephone number stored in the specific address for performing the audio conversation.

Execution of the dialing function using the number keys as the hot keys makes the dialing function more convenient for the user as it can be performed without manual input or retrieval of the telephone number corresponding to a destination. However, only the dialing function can be performed through the hot keys for an audio conversation connection in the communication functions, but other communication functions cannot be performed with the hot keys. So, use of the terminal can be more convenient for the user if other communication functions other than the audio conversation function can be performed with the hot keys.

### SUMMARY OF THE INVENTION

The present invention has been made to solve the foregoing problems and it is therefore an object of the present invention to provide a method of performing various user functions with hot keys in order to increase the convenience of a user.

According to an aspect of the invention to obtain the above object, there is provided a method of performing various communication functions with hot keys in a mobile communication terminal having an address book for storing destination addresses of communication counterparts defined according to address numbers, the method comprising the following steps of: confirming whether a multiple hot key function is set corresponding to an inputted number key; if the multiple hot key function is set, providing a user with a number of communication function items set as hot key functions; and setting a communication mode corresponding to a communication function of the communication function items selected according to user input and performing the set communication mode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the construction of a mobile communication terminal according to an embodiment of the invention;

FIG. 2 is a flow chart illustrating a process of allocating hot keys to various communication functions to set the various communication functions as hot key functions according to an embodiment of the invention;

FIG. 3 is a flow chart illustrating a process of a control unit for performing the various communication functions set to the hot-keys according to an embodiment of the present invention; and

FIG. 4 is a flow chart illustrating a process of the control unit for performing the various communication functions set to the hot-keys according to an embodiment of the invention.

### DETAILED DESCRIPTION OF THE PREFERRED EMBODIMENT

The following detailed description will present a preferred embodiment of the invention in reference to the accompanying drawings, in which well-known functions or constructions will not be described in detail since they would unnecessarily obscure the understanding of the invention.

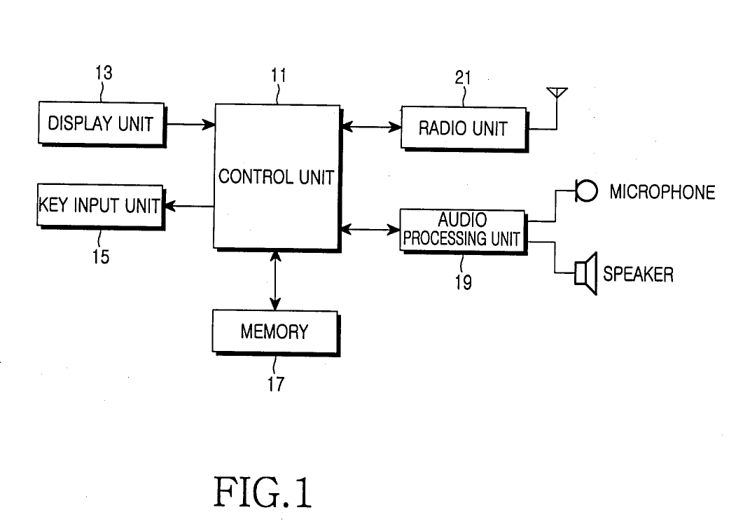

First, a description will be made about the structure of a mobile communication terminal according to an embodiment of the present invention with reference to FIG. 1. FIG. 1 is a block diagram illustrating the construction of the mobile communication terminal of the invention. As shown in FIG. 1, the mobile communication terminal of the invention has a control unit 11, a display unit 13, a key input unit 15, a memory unit 17, a radio unit 21 and an audio processing unit 19.

The control unit 11 performs a general control over the mobile communication terminal. The radio unit 21 controls transmission/receiving of audio and control data under the control of the control unit 11. Under the control of the control unit 11, the audio processing unit 19 converts the audio data received from the radio unit 21 into an audible sound to output the audible sound to a speaker as well as converts an audio signal received from a microphone into audio data to output the audio data to the radio unit 21. The key input unit 15 has a plurality of number keys and function keys, and outputs key input data to the control unit 11 corresponding to key inputs of a user. The display unit 13 displays various messages under the control of the control unit 11. The memory unit 17 stores program data necessary for controlling the operation of the mobile communication terminal and data produced during operations performed by the user. Also, the memory unit 17 stores data about an address book. The address book is a database constituting a number of sequential address numbers each storing the destination address of a communication counterpart such as a mobile communication terminal number, a wire terminal number, an e-mail address, and so on. Further, the address book stores program data about a multiple hot key setting menu, i.e. a menu for setting multiple hot keys, added according to the invention. The destination address stored in the address book can be searched through inputting numbers that are identical with the address numbers; and a telephone number of a destination number can be searched through inputting personal numbers except a telephone exchange number.

The multiple hot key setting menu functions to facilitate the setting of a number of communication functions as hot key functions so that the communication functions can be performed according to user selection when number keys are inputted as hot keys. The multiple hot key setting menu is comprised of lower hierarchy menus having a number of communication functions. Examples of the lower hierarchy menus include menus for short message, data transmission, e-mail, and so on. The short message menu is for allocating the hot key function to a short message service function, the data transmission menu to a radio data service function, and the e-mail menu to an e-mail service function.

The multiple hot key setting menu is added to a main menu, and when the menu for setting the multiple hot keys is selected according to user input, the control unit 11 displays the lower hierarchy menus on a display screen of the display unit 13. If the user selects one of the menus by inputting a key, the control unit 11 displays a message requesting whether a specific function corresponding to the selected menu will be set as a hot key function. If the user approves the request, the control unit 11 allocates a hot key function to the selected user function. For example, if the short message menu is selected and then approved by the user, the control unit 11 allocates a hot key function to the short message service function.

The communication functions set as the hot key functions are performed according to user selection when the number keys are inputted as the hot keys. If a specific number key is inputted as the hot key when the multiple hot key function is set, previously set communication function items are displayed and a specific hot key function is performed according to user selection. That is to say, if any number key is inputted for a predetermined time or longer when the short message service function is set as the hot key function, the control unit 11 displays the menus of ‘shortened dial’ and ‘short message.’ If the ‘short message’ menu is selected by the user, the short message function is performed to set a short message-writing mode. If the user writes a desired short message and makes an input requesting transmission, the written short message is transmitted into a mobile communication terminal having the telephone number stored in the address book corresponding to the inputted number key.

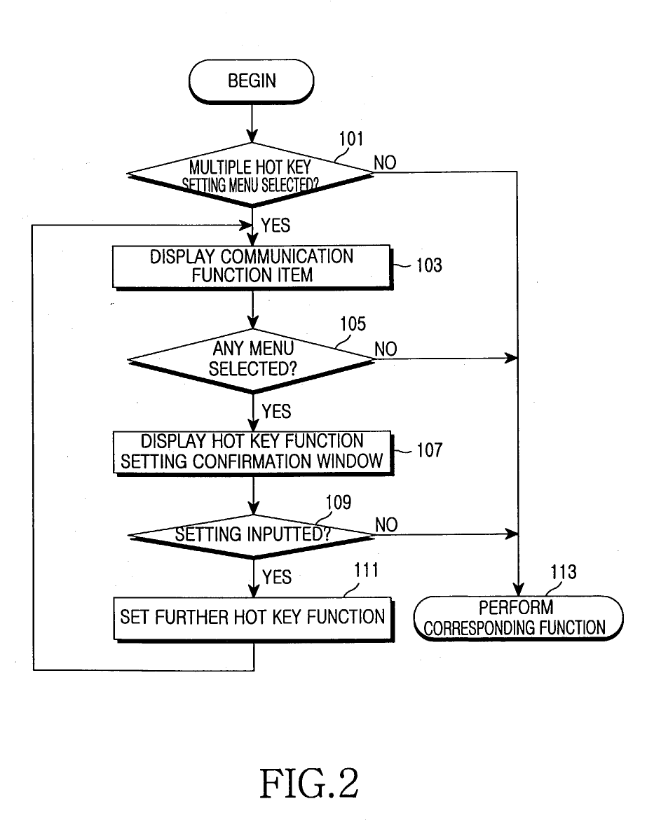

The above process will be described in reference to FIGS. 2 to 4. First, a description will describe a process of setting the communication functions as the hot key functions in reference to FIG. 2. FIG. 2 is a flow chart illustrating a process of allocating hot keys to various communication functions to set the various communication functions as the hot key functions according to an embodiment of the invention.

If the multiple hot key setting menu is selected according to input in step 101, the control unit 11 shown in FIG. 1 proceeds to step 103 to perform a corresponding function. If an input other than the multiple hot key setting menu is performed, the control unit 11 proceeds to step 113. In step 103, the control unit 11 displays communication function items, and then proceeds to step 105. In step 105, the control unit 11 determines whether any menu is selected from the displayed menus, and if the input is performed, proceeds to step 107; otherwise, the control unit 11 proceeds to step 113. In step 107, the control unit 11 displays a window for confirming whether a hot key function is set. If the user inputs to approve the hot key function setting in step 109, the control unit 11 proceeds to step 111; otherwise, the control unit 11 proceeds to step 113. In step 111, the control unit 11 sets the multiple hot key function by further allocating the hot key function, and then proceeds to step 103. In step 103, the control unit 11 repeatedly performs step 105 to step 111 if any menu is selected according to user input again. That is to say, a number of communication functions can be additionally set as the hot key functions according to user selection.

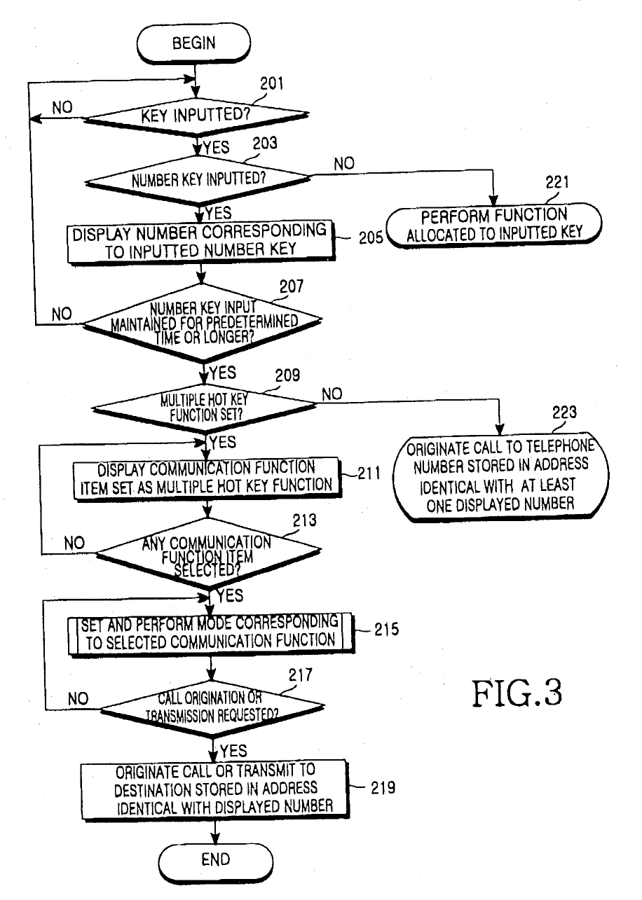

FIG. 3 is a flow chart illustrating a process for performing, by the control unit 11, the various communication functions set to the hot-keys. A maintaining time of key input is considered as the determination criterion for input of the multiple hot key in respect to any key in the embodiment of the invention. If any key input is maintained for a predetermined time or longer, the corresponding key operates as the multiple hot key.

Referring to FIG. 3, the control unit 11 confirms whether a key input is performed in step 201. If the key input is performed, the control unit 11 proceeds to step 203, else returns to step 201. The control unit 11 confirms whether the inputted key is a number key. If the inputted key is a number key, the control unit 11 proceeds to step 205; otherwise, the control unit proceeds to step 221 to perform a function allocated to the inputted key. In step 205, the control unit 11 displays a number corresponding to the inputted number key, and then proceeds to step 207. In step 207, the control unit 11 determines whether the above number key input is maintained for the predetermined time or longer. If the input is maintained, the control unit 11 proceeds to step 209; otherwise, the control unit 11 proceeds to step 201 to repeat step 201 through step 207. In step 209, the control unit 11 determines whether the multiple hot key function is set. If the multiple hot key function is set, the control unit 11 proceeds to step 211; otherwise, the control unit 11 proceeds to step 223. In step 223, the control unit 11 transmits a signal to an address identical with the displayed number.

In step 211, the control unit 11 displays the communication function item set as the multiple hot key function and then proceeds to step 213. In step 213, the control unit 11 confirms whether a communication function menu is selected, and if the communication function menu is selected, proceeds to step 215; otherwise, the control unit 11 proceeds to step 211. In step 215, the control unit 11 sets a mode corresponding to the selected communication function and performs the mode. In step 217, the control unit 11 confirms whether a call origination or transmission is requested, and if such a request is made, proceeds to step 219; otherwise, the control unit 11 proceeds to step 215. In step 219, the control unit 11 performs call origination or transmission to a destination stored in the address identical with the displayed number an then terminates the process. For example, if the short message service function is selected in step 213, the control unit 11 sets a short message writing mode to write a short message according to user input. If the transmission is requested in step 217, the control unit 11 transmits the written short message into a mobile communication terminal stored in the corresponding address in step 219 and then terminates the process.

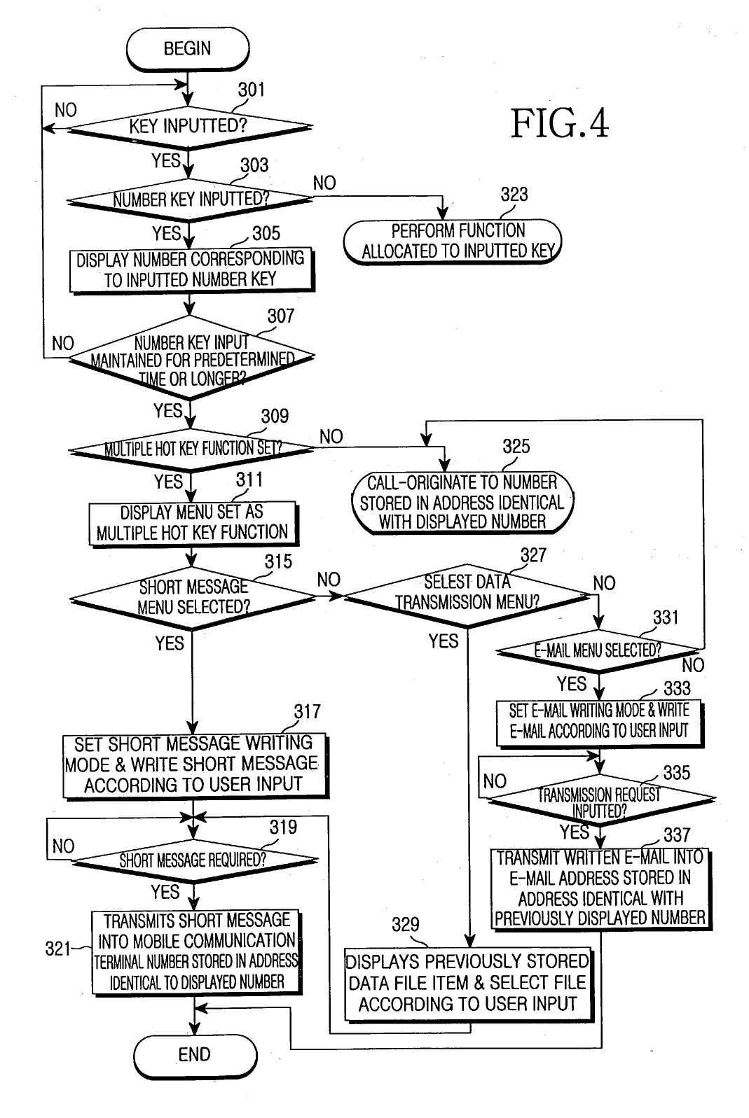

Detailed description will present an embodiment of the process in FIG. 3 in reference to FIG. 4. FIG. 4 is a flow chart illustrating a process of the control unit for performing the various communication functions set to the hot-keys according to the embodiment of the invention, in which hot keys are allocated to the short message service function, the radio data transmission/receiving function and the e-mail service function to set these functions as the hot key functions.

Referring to FIG. 4, the control unit 11 confirms whether a key is inputted in step 301, and if a key is inputted, proceeds to step 303; else, the control unit returns to step 301. In step 303, the control unit 11 confirms whether the inputted key is a number key, and if the inputted key is a number key, proceeds to step 305; otherwise, the control unit 11 proceeds to step 323 to perform a function allocated to the inputted key. In step 305, the control unit 11 displays a number corresponding to the inputted number key, and then proceeds to step 307. In step 307, the control unit 11 determines whether the above number key input is maintained for a predetermined time or longer, and if the input is maintained for a predetermined time or longer, control unit 11 proceeds to step 309; otherwise, the control unit 11 proceeds to step 301 to repeat step 301 through step 307. In step 309, the control unit 11 determines whether the multiple hot key function is set, and if the multiple hot key function is set, proceeds to step 311; otherwise, the control unit 11 proceeds to step 325. In step 325, the control unit 11 originates a call to a telephone number stored in an address identical with the displayed number.

In step 311, since the multiple hot key function is set, the control unit 11 displays menus set as the multiple hot key functions such as a short message menu, a data transmission menu and an e-mail menu, and then proceeds to step 315. In step 315, the control unit 11 confirms whether the short message menu is selected according to user input, and if the short message menu is selected, proceeds to step 317; otherwise, the control unit 11 proceeds to step 327. In step 317, the control unit 11 sets a short message writing mode and writes a short message according to user input, and then proceeds to step 319. If transmission for the written short message is required according to user input in step 319, the control unit 11 proceeds to step 321; otherwise, the control unit 11 returns to step 319. In step 321, the control unit 11 transmits the short message into a mobile communication terminal number stored in an address identical to the displayed number, and then terminates the process.

Again in step 315, if the short message menu is not selected from the displayed menus, the control unit 11 proceeds to step 327. In step 327, the control unit 11 confirms whether the data transmission menu is selected according to user input, and if the data transmission menu is selected, proceeds to step 329; otherwise, the control unit 11 proceeds to step 331. In step 329, the control unit 11 displays a previously stored data file item and selects any file according to user input, and then proceeds to step 319 to transmit the selected file to a corresponding destination. The data file means a still screen image, an MP3 file and so on which the mobile communication terminal utilizes as the initial screen.

In the meantime, if the data transmission menu is not also selected according to user input in step 327, the control unit 11 proceeds to step 331. In step 331, the control unit 11 confirms whether the e-mail menu is selected according to user input, if the e-mail menu is selected, proceeds to step 333; otherwise, the control unit 11 proceeds to step 325. In step 333, the control unit 11 sets an e-mail writing mode and writes an e-mail according to user input. In the following step 335, the control unit 11 confirms whether transmission request is inputted from the user, and if the request is inputted, proceeds to step 337; else returns to step 335. In step 337, the control unit 11 transmits the written e-mail into an e-mail address stored in an address identical with the previously displayed number, and then terminates the process.

As the various communication functions are set as the hot key functions and the number keys are inputted as the hot keys as set forth above, the various communication modes are set according to user input and the corresponding communications are performed in respect to the destinations stored in the addresses identical with the inputted numbers so as to enhance the user's convenience.

Although the preferred embodiment of the present invention has been disclosed for illustrative purposes, those skilled in the art will appreciate that various modifications, additions and substitutions can be made without departing from the scope and spirit of the invention as disclosed in the accompanying claims.

What is claimed is:

1. A method of performing communication functions with hot keys in a mobile communication terminal having an address book for storing destination addresses of communication counterparts defined according to address numbers, the method comprising the steps of:
confirming whether a multiple hot key function is set corresponding to an inputted number key;
if the multiple hot key function is set, providing a user with a number of communication function items set as hot key functions;
setting a communication mode corresponding to a communication function of the communication function items selected according to user input; and
performing the set communication mode.

2. The method of performing communication functions according to claim 1, further comprising the step of transmitting a result of the set communication mode to a destination address stored in the address book corresponding to the inputted number key at the user's request for transmission of the result.

3. The method of performing communication functions according to claim 1, wherein the communication functions include a short message service function, a radio data transmission function, a voice phone function, a video phone function and an e-mail transmission function.

4. The method performing communication functions according to claim 1, further comprising the step of: originating a call to a destination address stored in the address book identical with the displayed number if the multiple hot key function is not set.

5. A method of performing communication functions with hot keys in a mobile communication terminal having an address book for storing destination addresses of communication counterparts defined according to address numbers, the method comprising the steps of:
if at least one number key is inputted, displaying a number corresponding to the inputted number key, and if the time maintained for inputting the last number key is longer than a predetermined time, confirming whether a multiple hot key function is set;
if the multiple hot key function is set, providing a user with a number of communication function items set as hot key functions;
if a short message service function is selected from the provided communication function items according to user input, setting a short message writing mode and writing a short message according to user input; and
transmitting the written short message to a destination address stored in the address book identical with the displayed number at the user's request for transmission.

6. The method performing communication functions according to claim 5, further comprising the steps of:
if a radio data transmission/receiving function is selected from the provided communication items, displaying a previously stored data file item and selecting a file according to user selection; and
transmitting the selected data file to a destination address stored in the address book identical with the displayed number at the user's request for transmission.

7. The method performing communication functions according to claim 5, further comprising the steps of:
if an e-mail transmission/receiving function is selected from the provided communication functions, setting an e-mail writing mode to write an e-mail according to user input; and
transmitting the written e-mail to a destination address stored in the address book identical with the displayed number at the user's request for transmission.

8. A mobile communication terminal, comprising:
a memory for storing a number of destination addresses capable of searching according to a plurality of number keys inputted; and
a control unit for, upon receipt of the number keys, providing a number of communication function items which are preset to a user interface, performing an arbitrary communication mode selected according to a user input among the communication function items, and transmitting a result of the selected communication mode to a destination address corresponding to the inputted number keys.
